(19) United States
(12) Patent Application Publication
(10) Pub. No.: US 2006/0147661 A1
(43) Pub. Date: Jul. 6, 2006

(54) Smoke-permeable, drawn, seamless tubular casing and use thereof as casing for foodtuffs

(75) Inventors: Wilhelm Tobben, Kassel (DE); Heinrich Henze-Wethkamp, Walsrode (DE)

Correspondence Address: CONNOLLY BOVE LODGE & HUTZ, LLP, P O BOX 2207, WILMINGTON, DE, 19899, US

(73) Assignee: Casetech GmbH & Co. KG, Walsrode (DE)

(21) Appl. No.: 10/567,956

(22) PCT Filed: Aug. 2, 2004
(86) PCT No.: PCT/EP04/08630

§ 371 Date: Mar. 9, 2006

(30) Foreign Application Priority Data
Aug. 12, 2003 (DE) 103370102

(51) Int. Cl. A22C 13/00

(52) U.S. Cl. 428/34.8

(57) ABSTRACT

A one- or multi-layered seamless tubular casing which is permeable to smoke, characterized in that at least one layer of the seamless tubular casing comprises a mixture of polyamide and natural fibres and optionally additives, wherein the sum of the layer thicknesses is between 5 and 200 μm and the permeability of the seamless tubular casing to water vapour, in accordance with ASTM F1249-01 at a temperature of 23° C. and a relative atmospheric humidity of 85%, is at least 25 cm³/(m²×day×bar), is described.

The invention relates to a coextruded biaxially or uniaxially stretched or non-stretched seamless at least one-layered casing which is permeable to smoke and can be formed to a heat-set tube. It is used as a wrapping for paste-like or liquid foodstuffs or also for non-foodstuffs and is particularly suitable as an artificial sausage casing having nature-identical haptical properties and visual properties for smoked foodstuffs, such as, for example, sausage.

Natural gut and casings or tubular casings of natural gut, regenerated cellulose or collagen have hitherto chiefly been employed for the production of smoked foodstuffs, specifically sausage goods. The production of these products is expensive technically and financially and requires the use of special installations. A further complication is that collagen gut contains connective tissue protein and the consumer would like to replace products with animal raw materials.

Due to the high permeability of collagen and cellulose casings to water vapour, a criticism is the undesirable drying out of the goods after a relatively long storage time. As an alternative to this, casings made of plastics can be employed. Tubular casings of thermoplastics are widespread on the market and are distinguished by their good barrier properties. Unfortunately, foodstuffs casings having a good barrier property cannot be smoked. It is known from Savic, Z.: Sausage Casings, VICTUS Lebensmittelindustriebedarf, Vienna, Austria, p. 245-300 and Kohan, Melvin I.: Nylon Plastics Handbook, Carl Hanser Verlag, Munich Vienna New York, 1995, p 151-190 that the blown film or the double bubble process can be employed for the production of such tubular casings.

However, depending on the goods to be produced or to be packaged, extensive specific requirements must be met in order to comply with the uses in practice. In sausage production, for example, these use properties requirements can include:
high or low barrier properties
heat resistance up to the sterilization temperature
good adhesion to the filling
good tear propagation resistance during hot storage
adequate shrinkage
high strength, dimensional stability, tautness
good peeling properties, easy peelability
good hot and cold slicing properties
easy fabrication, in particular gatherability and
good dippability, in particular cold and hot dippability
good colourability and colour covering
good printability and reliable adhesion of printing ink
acceptability according to foodstuffs law (EC guidelines, Bundesamt für gesundheitlichen Verbraucherschutz und Veterinärmedizin GBVV, Food and Drug Administration FDA)
ecological acceptability of the materials used.

In addition, nature-identical haptical properties and a visually pleasing appearance such as is already known for collagen, cellulose and fibre guts is required more and more frequently.

It is known from EP-A 139 888 that an increased water uptake of at least 5 percent by weight is possible by the use of aliphatic polyamide, so that passage of smoke to the sausage is possible in the presence of water or water vapour. The example products showed only an inadequate passage of smoke by means of a smoking chamber of regulated climate.

EP-A 0 920 808 discloses a one-layered tubular casing which is said to ensure a noticeable smoke flavour by the use of cellulose acetate propionate as the matrix material. The possibility that a polyamide and/or a cellulose powder can be admixed to the cellulose acetate propionate is furthermore described. Processing of this mixture is critical, since the cellulose powder can undergo thermal decomposition. During production of such a tubular casing, adjustment of the correct process parameters, such as, for example, screw speed and heating belt temperature, is difficult and the production is to be evaluated as correspondingly critical. Thus, for example, an increase in throughput by increasing the screw speed can lead, due to increased dissipation, to undesirable temperature peaks and therefore to a thermal damage to the cellulose powder. A change in process parameters of usual practice is consequently not ensured. Furthermore, due to the use of cellulose acetate propionate as the matrix material, the processing properties of this sausage casing present problems, since this material is distinguished by a poor stretching ratio. It is thus disclosed in EP-A 0 929 808 that it was possible to achieve a maximum stretching ratio of 2 in the longitudinal and transverse direction in the example casing. Savic, Z.: Sausage Casings, VICTUS Lebensmittelindustriebedarf, Vienna, Austria, p. 267-277 already describes the need for a high stretching ratio to improve the mechanical and visual properties of the tubular casing. A tubular casing having a low degree of stretching must have a higher wall thickness than a highly stretched casing because of a low mechanical strength. However, a high wall thickness of the casing involves a high barrier action, so that the aim of a high permeability to water vapour with a low area stretching ratio cannot be realized to the optimum. A low area stretching ratio furthermore means that the desired mechanical properties, such as cylindricity of the casing, tear propagation resistance and taut visual properties cannot be adjusted to suit the consumer by the stretching parameters. It can thus be said that the tear propagation properties are poor because of the wall thickness and the choice of material and such casings tend to wrinkle, so that unsympathetic visual properties result. In addition, it may be said that the use of a cellulose powder having the narrow particle size distribution described of 90% between 50-400 μm leads to an unnaturally uniformly structured surface. Finally, it must be stated that the object of the invention set in the patent EP-A 0 920 808 of developing a synthetic casing which is permeable to smoke and can replace a fibre gut has not been achieved.

It is known from WO 02/078455 and WO 99/07227 that by the use of finely dispersed hydrophilic materials (drop diameter of 0.1-3 μm), such as vinyl alcohol, vinylpyrrolidone or vinyl alcohol esters, the permeability to water vapour can be increased by flushing out of these water-soluble materials from the casing during soaking in water. By the addition of inorganic salts as hydrophilic material, vacuoles can additionally be generated during stretching of the casing, so that there is an increased permeability to water. The casings which are permeable to smoke and are produced in this way have the disadvantage that the dimensional stability of the end product can be achieved only with difficulty, and that there is a heavy water loss during storage due to the defects in the casing. Furthermore, the production of such a mixture presents problems and requires a procedure which is expensive and cost-intensive in terms of process technology for the dispersed goods required. The visual and haptical properties seem synthetic and are therefore less attractive to the viewer.

WO 02094023 is also based on the inclusion of bubbles by a bubble forming agent. Here also, an increased water loss during storage and a critical process procedure are to be presumed. Mechanical weakening is to be expected due to the vacuoles in the gut, so that filling of these tubular casings must be carried out very cautiously and consequently not in a practice-orientated manner. The mechanical properties required by the consumer, such as, for example, absence of wrinkles, dippability, tear propagation resistance and cylindricity, can be fulfilled only inadequately.

The customer increasingly requires synthetic casings which can be smoked and which represent a good compromise of water loss during storage and smoke flavour and nevertheless meet all the use requirements, in particular the mechanical, haptical and visual demands of the consumer. There was therefore the object of developing a tubular casing which has a very good permeability to smoke without a critical weight loss occurring during storage for a long time. Furthermore, smoking under the conditions conventional for scalding sausage, such as, for example, hot smoking, should be possible with this casing. The production should moreover be non-critical and inexpensive, so that a mechanically, haptically and visually pleasing and nevertheless economical product can be produced.

This object has been achieved by the development of a coextruded biaxially or uniaxially stretched or non-stretched seamless at least one-layered casing which has been formed to a heat-set tube and is based on a polyamide/natural fibre mixture having fibre lengths of between 5 to 10,000 μm. The use of natural fibre threads, tapes or nets is also conceivable. This tubular casing can be produced via the blown film or double bubble processes which are known per se. Processing by other processes, such as the flat film, injection moulding or rotation process, is also conceivable. Processing of this mixture is possible both on twin-screw extruders and on single-screw extruders with or without a devolatilization zone. The use on single-screw extruders with a grooved barrel with or without a devolatilization zone, which are used particularly frequently for tubular casing production since processing is non-critical because of a short dwell time and low average material temperature, is preferred.

The present invention therefore provides an at least one-layered tubular casing which is permeable to smoke, characterized in that at least one layer of the seamless tubular casing comprises a mixture of polyamide and natural fibres and optionally additives, wherein the sum of the layer thicknesses is between 5 and 200 μm and the permeability of the casing to water vapour, in accordance with ASTM F1249-01 at a temperature of 23° C. and a relative atmospheric humidity of 85%, is at least 25 cm³/(m²×day×bar).
The seamless tubular casing according to the invention can have a one- or multi-layered build-up.
Preferably, at least one layer of the casing comprises a mixture of natural fibres (fibre length of 5-10,000 μm) and a mixture of aliphatic polyamide from the group consisting of PA6, PA11, PA12, PA66, PA6.8, PA6.9, PA6.10, PA6.11 or PA6.12 with a copolymer from the monomer units contained therein or a mixture of the aliphatic polyamides mentioned.
Particularly preferably, at least one layer of the tubular casing comprises 30 wt. % to 99.9 wt. % of an aliphatic polyamide and/or copolyamide and/or a mixture of the same and/or (partly) aromatic PA and/or olefinic (co)polymer (such as e.g. EVA, EVOH, ionomer resin) and/or (co)polyester and 0.1 wt. % −70 wt. % of fibres, based on the total weight of the polymer mixture of this layer.
Preferably, the fibre content mixed in is a mixture of various types and/or lengths, a cellulose fibre content particularly preferably being a bimodal mixture of fibres of the same or different type of various lengths.
The sum of the layer thicknesses is conventionally between 5 and 100 μm, preferably 20-50 μm and particularly preferably 20-30 μm.
Preferably, the natural fibres are cellulose fibres which can be processed by means of a compound, masterbatch or by direct mixing in.
The permeability of the casing to water vapour, in accordance with ASTM F1249-01 at a temperature of 23° C. and a relative atmospheric humidity of 85%, is conventionally at least 25 cm³/(m²×day×bar).

The present invention provides the process for the production of such a tubular biaxially stretched foodstuffs casing which is permeable to smoke.

The tubular casing according to the invention is expediently produced via an extrusion process. The raw material in the form of fibre, granules or powder is compressed, melted and homogenized in an extruder and discharged via a die and formed to a seamless tube. The primary tube emerging is cooled by means of air-cooling or water-cooling and then simultaneously stretched biaxially. A particularly suitable process in this context is simultaneous biaxial stretching by means of double bubble technology, in which the stretching of the primary bubble takes place via an internal pressure which is applied. The casing can then be subjected to a heat treatment for targeted adjustment of the shrink properties. The seamless tubular casing can be coloured by addition of coloured pigments as required, a multi-layered build-up having the particular advantage of colouring of one or more layers, so that a particularly good colour intensity, colour accuracy and colour covering can be achieved.

It is known that thermal and mechanical damage may occur during processing of natural fibres. Thermal damage manifests itself by inhomogeneities, such as e.g. in the form of specks and/or burns. Mechanical damage can be detected by an undesirable reduction in fibre length and fibre diameter and the distribution thereof Surprisingly, it has been possible for natural fibre to be mixed into the polyamide matrix without significant thermal damage. By a suitable process procedure, it has been possible here simultaneously to adjust the mechanical damage to the fibres as required. It was furthermore surprising that the haptical and visual properties of the seamless tubular casing produced were similar to those of a natural, cellulose fibre or collagen gut, with a more economical production. Astonishingly, the mechanical properties of the tubular casing were very good. It was thus possible to dip and gather the tube without this bursting or propagating tears during subsequent scalding. The barrier properties, such as, for example, permeability to water vapour and oxygen, can be adapted via the fibre content, so that use in tubular casings having a high barrier action and a natural appearance is also conceivable. An oxygen barrier is known to prevent a negative change, such as e.g. premature. greying of the cooking product facing the inside of the tubular casing, during storage. The water vapour barrier is known to prevent the weight loss of the sold goods induced by evaporation of water from the filling during storage, which on the one hand reduces the profit of the product and on the other hand can lead to wrinkled unattractive products as a result of volume shrinkage.

The seamless tubular casing preferably comprises at least one layer of a polyamide and cellulose fibres. The polyamide comprises as the main component either an aliphatic homopolyamide or an aliphatic copolyamide or a blend of aliphatic homo- and copolyamide or a blend of aliphatic homo- or copolyamide and a partly aromatic polyamide. Suitable aliphatic homo- and copolyamides are those polyamides such as are described in a general manner in Kunststoffhandbuch Part 3/4 “Polyamide” page 22 et seq., Carl Hanser Verlag Munich Vienna 1998. The aliphatic polyamide is a homopolyamide of aliphatic primary diamines and aliphatic dicarboxylic acids or a homopolymer or -amino-carboxylic acids or lactams thereof. The aliphatic copolyamide contains the same units and is e.g. a polymer based on one or more aliphatic diamines and one or more dicarboxylic acids and/or one or various co-aminocarboxylic acids or lactams thereof. The aliphatic primary diamines contain, in particular, 4 to 8 C atoms. Suitable diamines are tetra-, penta-, hexa- and octamethylenediamine, and hexamethylenediamine is particularly preferred. The aliphatic dicarboxylic acids contain, in particular, 4 to 12 C atoms. Examples of suitable dicarboxylic acids are adipic acid, azelaic acid, sebacic acid and dodecanedicarboxylic acid. The ω-aminocarboxylic acid or lactams thereof contain 6 to 12 C atoms. An example of ω-aminocarboxylic acids is 11-aminoundecanoic acid. Examples of lactams are ε-caprolactam and ω-laurolactam. Particularly preferred aliphatic polyamides are polycaprolactam (PA 6) and polyhexamethyleneadipamide (PA66). A particularly preferred aliphatic copolyamide is PA 6/66, which consists of caprolactam units, hexamethylenediamine units and adipic acid units. Partly aromatic polyamides are described in Kunststoffhandbuch Part 3/4 “Polyamide” page 803 et seq., Carl Hanser Verlag Munich Vienna 1998.

In the partly aromatic polyamides and copolyamides, either the diamine units can predominantly or exclusively form the aromatic units, while the dicarboxylic acid units are predominantly or exclusively of an aliphatic nature, or the diamine units are predominantly or exclusively of an aliphatic nature while the dicarboxylic acid units predominantly or exclusively form the aromatic unit. Examples of the first embodiment are partly aromatic polyamides or copolyamides in which the aromatic diamine units comprise m-xylylenediamine and phenylenediamine. The aliphatic dicarboxylic acid units of this embodiment usually contain 4 to 10 C atoms, such as e.g. adipic acid, sebacic acid and azelaic acid.

In addition to the aromatic diamine units and the aliphatic dicarboxylic acid units, aliphatic diamine units and aromatic dicarboxylic acid units can also additionally be present in amounts of in each case up to 5 mol %. A particularly preferred embodiment comprises m-xylylenediamine units and adipic acid units. This polyamide (PA-MXD6) is marketed e.g. by Mitsubishi Gas Chemical Company Inc. under the name MX-Nylon. Examples of this second embodiment are partly aromatic polyamides and copolyamides in which the aliphatic diamines usually contain 4 to 8 C atoms. Among the aromatic dicarboxylic acids, isophthalic acid and terephthalic acid are to be singled out in particular. In addition to the aliphatic diamine units and the aromatic dicarboxylic acid units, aromatic diamine units and aliphatic dicarboxylic acid units can also additionally be contained in amounts of in each case up to 5 mol %.

The seamless tubular casing can be non-stretched or uniaxially or biaxially stretched. Preferably, the casing is biaxially stretched with an area stretching ratio of 4-10 and particularly preferably of 6-10. The degree of reshrinkage can be adjusted by the heat setting, a shrinkage at 100° C. in a water-bath of 0-30% preferably being established, and particularly preferably a shrinkage of 10-20%.

The natural fibres mixed in can be fibres based on polysaccharides, such as e.g. cellulose fibres from plants, such as e.g. hemp, jute, linen, bamboo, coconut or wood, or also cellulose fibres from regenerated cellulose from the viscose or lyocell process, or natural mineral fibres, such as carbon fibres. Preferably, a cellulose fibre of a hardwood, softwood or conifer having a length of 5-10,000 μm, preferably having a 95% content having the length of 5-35 μm and/or 35-350 μm and/or 350-10,000 μm, particularly preferably having the length of 5-35 μm and/or 350-10,000 μm at a diameter of 2-30 μm, is employed. The fibres can also be employed as a mixture thereof, particularly preferably as a bimodal mixture thereof. The bulk density of such cellulose fibres varies between 20-600 g/l, depending on the fibre length and type. The fibres can be thermally and/or physically and/or chemically pretreated.

The amount of fibres mixed into the layer is between 0.1-70%, preferably between 0.1-10% and particularly preferably between 0.1-7 percent by weight. The amount of fibre mixed in can comprise various fibre types and/or fibre lengths, and a mixture of various fibre types and/or fibre lengths is particularly preferred.

The natural fibres can be processed by means of a compound or masterbatch based on an aliphatic polyamide, such as PA6, PA11, PA12, PA66, PA6/66, PA6.8, PA6.9, PA6.10, PA6.11 or PA6.12, and/or other thermoplastics or by direct mixing in. A compound or masterbatch based on a low-melting polyamide, such as PA6/66 and/or PA12, is preferred. The layers of the casing can include additives, such as lubricants, antiblocking agents, nucleating agents, fillers and coloured pigments or a mixture of these. The layers of the casing can furthermore comprise hydrophilic materials, such as vinylpyrrolidone, vinyl alcohol, alkyloxazolines, alkylene glycol, acrylamide, alkylene oxide, acrylic acid, methacrylic acid, maleic anhydride, vinyl alcohol ether, vinyl alcohol ester, cellulose ether, polylactide (PLA), polyphosphazenes or polysiloxanes.

The masterbatch and/or compound can be prepared as granules or as a powder. The granule form, which can be spherical or cylindrical, is preferred. Cylindrical granules of between 2-7 mm length of 1-4 mm diameter having a porous character, which can be realized by a specific preparation and leads to a reduced shearing force in the smooth and grooved solids zone of the extruder, are particularly preferred. The masterbatch and/or compound can optionally be predried.

The casing can be produced with the aid of the blown film or double bubble process, it being possible for a twin- or single-screw extruder to be used. The double bubble process is preferred.

The present invention also provides the use of the seamless tubular casing according to the invention as a wrapping material for paste-like or liquid fillings. The particular advantage of a seamless tubular casing is that continuous, spiral-shaped peeling of the sausage is possible without being limited by imperfections, such as, for example, a joining seam. In addition, the visual and haptical impression and the mechanical integrity of the seamless tubular casing during production of, for example, sausage are excellent, without being impaired by a seam. It is preferably employed here as a sausage casing for sausage meat which is furthermore also subjected to smoking. Examples of smoked sausage types are boiling sausages, such as liver sausage and blood sausage, scalding sausages, such as smoked sausage, beer sausage, ham sausage and boiled ham, and uncooked sausage, such as salami, or also further foodstuffs, such as cheese.

The advantages of the tubular film according to the invention are to be illustrated in the following examples.

### COMPARISON EXAMPLE 1

A pure PA6/66 (viscosity number=195, melting point=196° C., film type) was processed to a thermally and mechanically homogeneous melt on a single-screw extruder and extruded through an annular die and formed to a tube. After the forming, the tube was cooled rapidly so that an average wall thickness of 60 μm was retained. This is a slightly biaxially stretched tube of plastic.

### COMPARISON EXAMPLE 2

A multi-layered seamless tubular casing comprising 3 layers
1. 93% PA 6 (viscosity number=225, film type) and 7% antiblocking masterbatch having a layer thickness of 5 μm (inner layer)
2. 100% PA6/66 (viscosity number=195, melting point=196° C., film type) having a layer thickness of 20 μm (middle layer)
3. 100% PA6/66 (viscosity number=195, melting point=196° C., film type) having a layer thickness of 5 μm (outer layer)
   was formed to a primary tube on three single-screw extruders via an annular die. The tube was cooled rapidly and then heated to the minimum temperature required for the stretching, stretched biaxially to a high degree with the aid of compressed air acting on the inside and then heat-set in a further heating zone. It was possible for the mechanical properties of the tube to be adjusted via the heat setting, and the tube had an average wall thickness of 30 μm.

### EXAMPLE 1

A mixture of 95% PA6/66 (viscosity number=195, melting point=196° C., film type) and 5% cellulose fibres (hardwood cellulose of ØL=23 μm and ØD=17 μm) was processed to a compound in an extruder and then processed to a homogeneous melt on a single-screw extruder and extruded through an annular die and formed to a seamless tube. After the forming, the tube was cooled rapidly to a seamless tubular casing, so that an average wall thickness of 60 μm was retained. This is a slightly biaxially stretched tube of plastic.

### EXAMPLE 2

A mixture of 95% PA6/66 (viscosity number=195, melting point=196° C., film type) and 5% microcrystalline cellulose of ØL=25 μm and ØD=17 μm) was processed to a compound in an extruder and then processed to a homogeneous melt on a single-screw extruder and extruded through an annular die and formed to a tube. After the forming, the tube was cooled rapidly, so that an average wall thickness of 60 μm was retained. This is a slightly biaxially stretched tube of plastic.

### EXAMPLE 3

A multi-layered seamless tubular casing comprising 3 layers
1. 93% PA6 (viscosity number=225, film type) and 7% antiblocking masterbatch having a layer thickness of 5 μm (inner layer)
2. 99% PA6/66 (viscosity number=195, melting point=196° C., film type). and 1% cellulose fibres (0.5% hardwood cellulose of ØL=60 μm and ØD=20 μm and 0.5% hardwood cellulose of ØL=23 μm and ØD=17 μm) having a layer thickness of 20 μm (middle layer)
3. 100% PA6/66 (viscosity number=195, melting point=196° C., film type) having a layer thickness of 5 μm (outer layer)
   was formed to a primary tube on three single-screw extruders via an annular die. The tube was cooled rapidly and then heated to the minimum temperature required for the stretching, stretched biaxially to a high degree with the aid of compressed air acting on the inside and then heat-set in a further heating zone. It was possible for the mechanical properties of the tube to be adjusted via the heat setting, and the tube had an average wall thickness of 30 μm.

### EXAMPLE 4

A multi-layered seamless tubular casing comprising 3 layers
1 93% PA6 (viscosity number=225, film type) and 7% antiblocking masterbatch having a layer thickness of 5 μm (inner layer)
2. 99% PA6/66 (viscosity number=195, melting point=196° C., film type) and 1% cellulose fibres (0.5% hardwood cellulose of ØL=60 μm and ØD=20 μm and 0.5% hardwood cellulose of ØL=23 μm and ØD=17 μm) having a layer thickness of 20 μm (middle layer)
3. 100% PA6/66 (viscosity number=195, melting point=196° C., film type) and 1% cellulose fibres (ØD=20 μm and 1.5% hardwood cellulose of ØL=23 μm and ØD=17 μm) having a layer thickness of 5 μm (outer layer)
   was formed to a primary tube on three single-screw extruders via an annular die. The tube was cooled rapidly and then heated to the minimum temperature required for the stretching, stretched biaxially to a high degree with the aid of compressed air acting on the inside and then heat-set in a further heating zone. It was possible for the mechanical properties of the tube to be adjusted via the heat setting, and the tube had an average wall thickness of 30 μm.

### EXAMPLE 5

A multi-layered seamless tubular casing comprising 3 layers
1. 97% PA6 (viscosity number=225, film type) and 3% antiblocking masterbatch having a layer thickness of 6 μm (inner layer)
2. 97% PA6/66 (viscosity number=195, melting point=196° C., film type) and 3% cellulose fibres (1.5% hardwood cellulose of ØL=60 μm and ØD=20 μm and 1.5% hardwood cellulose of ØL=23 μm and ØD=17 μm) having a layer thickness of 20 μm (middle layer)
3. 100% PA6/66 (viscosity number=195, melting point=196° C., film type) having a layer thickness of 5 μm (outer layer)
   was formed to a primary tube on three single-screw extruders via an annular die. The tube was cooled rapidly and then heated to the minimum temperature required for the stretching, stretched biaxially to a high degree with the aid of compressed air acting on the inside and then heat-set in a further heating zone. It was possible for the mechanical properties of the tube to be adjusted via the heat setting, and the tube had an average wall thickness of 30 μm.

### EXAMPLE 6

A multi-layered seamless tubular casing comprising 5 layers
1. 93% PA6 (viscosity number=225, film type) and 7% antiblocking masterbatch having a layer thickness of 6 μm (inner layer)
2. 98% PA6/66 (viscosity number=195, melting point=196° C., film-type) and 2% cellulose fibres (cellulose fibres (1% hardwood cellulose of ØL=60 μm and ØD=20 μm and 1% hardwood cellulose of ØL=23 μm, and ØD=17 μm) having a layer thickness of 5 μm (layer between the inner and middle layer)
3. 100% PA6 (viscosity number=225, film type) having a layer thickness of 5 μm (middle layer)
4. 100% PA6/66 (viscosity number=195, melting point=196° C., film type) having a layer thickness of 20 μm (layer between the middle and outer layer)
5. 97% PA6/66 (viscosity number=195, melting point=196° C., film type) and 3% cellulose fibres (1.5% hardwood cellulose of ØL=60 μm and ØD=20 μm and 1.5% hardwood cellulose of ØL=23 μm and ØD=17 μm) having a layer thickness of 5 μm (outer layer)
   was formed to a primary tube on three single-screw extruders via an annular die. The tube was cooled rapidly and then heated to the minimum temperature required for the stretching, stretched biaxially to a high degree with the aid of compressed air acting on the inside and then heat-set in a further heating zone. It was possible for the mechanical properties of the tube to be adjusted via the heat setting, and the tube had an average wall thickness of 41 μm.

### REFERENCE EXAMPLE 1

Commercial product “K norm” (5-layered biaxially stretched tube of plastic) from CaseTech GmbH & Co KG having a wall thickness of 41 μm.

### REFERENCE EXAMPLE 2

Commercially available collagen gut having a wall thickness of 130 μm.

Test Criteria:

Casing sections were soaked in-water for 30 min and then filled with fine-grained scalding sausage meat under a constant filling pressure and closed with metal clips at the ends. The sausages were then hung up, treated with smoke-saturated water vapour at 75° C. for 30 min in a scalding cabinet with a smoke generator and subsequently cooked thoroughly at 80° C. for 60 min with water vapour without smoke. The sausages were cooled to room temperature in air and then stored in a refrigerated chamber at about 6° C. Table 1 shows that the sausage meat in the casings according to the invention is significantly more intensely coloured after smoking and has a more intensive smoke flavour.

TABLE 1

| | CE | CE | | | | | | | RE | RE |
|---|---|---|---|---|---|---|---|---|---|---|
| | 1 | 2 | E 1 | E 2 | E 3 | E 4 | E 5 | E 6 | 1 | 2 |
| Smoke flavour | 5 | 2 | 2 | 2 | 1 | 1 | 1 | 3 | 6 | 1 |
| Smoke colour | 5 | 3 | 2 | 2 | 3 | 3 | 3 | 4 | 6 | 1 |
| Permeability to | 25 | 30 | 19 | 28 | 31 | 31 | 32 | 15 | 7 | 700 |
| water vapour | | | | | | | | | | |
| (g · m⁻² · d⁻¹) | | | | | | | | | | |
| Permeability to | 35 | 40 | 27 | 37 | 43 | 43 | 44 | 26 | 25 | 110 |
| oxygen | | | | | | | | | | |
| (ml · m⁻² · | | | | | | | | | | |
| d⁻¹ · bar⁻¹) | | | | | | | | | | |
| Weight loss | 2 | 5 | 4 | 4 | 2 | 2 | 2 | 2 | 1 | 4 |
| Peeling properties | 5 | 2 | 4 | 4 | 1 | 1 | 1 | 1 | 1 | 1 |
| Cylindricity | 5 | 2 | 5 | 5 | 2 | 2 | 2 | 2 | 2 | 2 |
| Nat. visual | 6 | 6 | 1 | 1 | 2 | 1 | 2 | 2 | 6 | 2 |
| properties | | | | | | | | | | |
| Nat. haptical | 6 | 6 | 1 | 1 | 2 | 1 | 2 | 2 | 6 | 2 |
| properties | | | | | | | | | | |
| Colour covering | 2 | 2 | 6 | 6 | 1 | 1 | 1 | 1 | 1 | 2 |
| Slicing properties | 5 | 3 | 4 | 4 | 1 | 1 | 1 | 1 | 4 | 2 |
| (hot) | | | | | | | | | | |
| Tear propagation | 4 | 4 | 1 | 1 | 1 | 1 | 1 | 1 | 4 | 3 |
| properties | | | | | | | | | | |
| Dipping properties | 6 | 4 | 1 | 1 | 1 | 1 | 1 | 1 | 6 | 2 |
| Surface structure | 6 | 6 | 1 | 1 | 2 | 1 | 2 | 1 | 6 | 2 |
| Ring properties | 4 | 2 | 4 | 4 | 2 | 2 | 2 | 2 | 2 | 2 |

Evaluation:
1 = very good
2 = good
3 = satisfactory
4 = sufficient
5 = deficient
6 = very deficient

The relevant properties of the multi-layered seamless tubular casing described in the following were determined as follows:

Smoke flavour: Subjective judgement from a tasting test by a panel of 4 experts (school note principle). Reference Example 2 gave the best possible result here of 1.

Smoke colour: Subjective judgement by a panel of 4 experts as a measure of the brown coloration of the cooking product surface after peeling off the shell (school note principle). Reference Example 2 gave the best possible result here of 1.

Permeability to water vapour: In accordance with ASTM F1249-01 at a temperature of 23° C. and a relative atmospheric humidity of 85%. The value indicates the amount of water vapour in grams which passes through a 1 m² area of the casing to be tested during one day (24 hours) under the stated test conditions.

Permeability to oxygen: The O2Pe is determined in accordance with DIN 53380 Part 3 at a temperature of 23° C. and a relative atmospheric humidity of 75%. The value indicates the volume of oxygen in millilitres which passes through a 1 m² area of the casing to be tested during one day (24 hours) under an oxygen partial pressure of 1 bar under the stated test conditions.

Weight loss: The casings to be tested are filled taut with oxidation-sensitive test filling (test cooking product based on scalding sausage) by means of a commercially available filling machine and closed on both sides by a clip. After weighing of the sausages obtained, these are stored in a storage chamber at room temperature. At the end of 20 days, the sausages are weighed again, the percentage weight loss resulting from the ratio of the difference in weight before and after storage to the weight before storage (school note principle).

Peeling properties: It was evaluated how easily the casing could be peeled off after being cut into and how good the peeling properties (e.g. change in direction during peeling) were (school note principle).

Cylindricity: Objective judgment via the difference in calibre between the sausage diameter at the top, middle and bottom (school note principle)

Natural visual properties: Subjective judgment via the visual impression, such as wrinkling and consistency of the sausages (school note principle)

Natural haptical properties: Subjective judgment via the haptical impression, such as firm handle and natural surface of the sausages (school note principle)

Colour covering: Subjective judgment via the colour intensity and colour accuracy of the filled coloured sausage casing before and after scalding (school note principle)

Slicing properties (hot): Objective judgment via the number and length of the tears caused during hot slicing (core temperature of the cooking product approx. 35° C.) (school note principle)

Tear propagation resistance: The casings to be tested are filled taut with test cooking product based on scalding sausage by means of a commercially available filling machine, and closed on both sides by a clip. After scalding and cooling, the samples approx. 50 cm long are halved and each half is cut into approx. 1 cm in the longitudinal direction at the sliced end. The samples are then stored hot at a temperature of 70° C. and a relative humidity of 30% for several hours. Evaluation is via the length of tear which develops during storage.

Dipping properties: Objective judgment via the number of torn or burst sausages during filling or scalding after cold dipping (school note principle)

Surface structure: Subjective judgment via the surface structure of the sausage (school note principle)

Ring properties: Objective judgment via the ring formation properties (school note principle)

1. One- or multi-layered seamless tubular casing which is permeable to smoke, characterized in that at least one layer of the casing comprises a mixture of polyamide and natural fibres and optionally additives, wherein the sum of the layer thicknesses is between 5 and 200 μm and the permeability of the casing to water vapour, in accordance with ASTM F1249-01 at a temperature of 23° C. and a relative atmospheric humidity of 85%, is at least 25 cm³/(m²×day×bar).

2. Seamless tubular casing according to claim 1, characterized in that it is biaxially or uniaxially stretched or non-stretched.

3. Seamless tubular casing according to claim 1, characterized in that at least one layer of the casing comprises a mixture of natural fibres and a mixture of aliphatic polyamide from the group consisting of PA6, PA11, PA12, PA66, PA6/66, PA6.8, PA6.9, PA6.10, PA6.11 and PA6.12, a copolymer from the monomer units contained therein or a mixture of the aliphatic polyamides mentioned.

4. Tubular film according to claim 1, characterized in that at least one layer of the casing comprises 30-99.9 wt. % of an aliphatic polyamide and/or copolyamide and/or a mixture of the same and/or (partly) aromatic PA and/or olefinic (co)polymer from the group consisting of (EVA, EVOH, ionomer resin) and/or (co)polyester and 0.1-70 wt. % of natural fibres, based on the total weight of the layer, the wt. % values of the polymer, additives and the natural fibres in each case adding up to 100 wt. %.

5. Seamless tubular casing according to claim 1, characterized in that the natural fibres are cellulose fibres having a fibre length in the range of from 5 to 10,000 μm.

6. Seamless tubular casing according to claim 1, characterized in that the seamless tubular casing comprises at least 3 layers, wherein
the inner layer comprises 30 to 100 wt. % of aliphatic polyamide from the group consisting of PA6, PA11, PA12, PA66, PA6/66, PA6.8, PA6.9, PA6.10, PA6.11 and PA6.12, a copolymer from the monomer units contained therein or a mixture of the aliphatic polyamides mentioned and 0 to 70 wt. % of cellulose fibres and optionally additives,
the middle layer comprises 30 to 100 wt. % of aliphatic polyamide from the group consisting of PA6, PA11, PA12, PA66, PA6/66, PA6.8, PA6.9, PA6.10, PA6.11 and PA6.12, a copolymer from the monomer units contained therein or a mixture of the aliphatic polyamides mentioned and 0 to 70 wt. % of cellulose fibres and optionally additives and
the outer layer comprises 30 to 100 wt. % of aliphatic polyamide from the group consisting of PA6, PA11, PA12, PA66, PA6/66, PA6.8, PA6.9, PA6.10, PA6.11 and PA6.12, a copolymer from the monomer units contained therein or a mixture of the aliphatic polyamides mentioned and 0 to 70 wt. % of cellulose fibres and optionally additives.

7. (canceled)

8. (canceled)

9. A wrapping for paste-like or liquid fillings which comprises the seamless tubular casing according to claim 1.

10. The wrapping as claimed in claim 9, wherein the paste-like filling is sausage meat.

11. The seamless tubular casing according to claim 1, wherein the sum of the layer thicknesses is between 5 and 100 μm.

12. The seamless tubular casing according to claim 1, wherein the sum of the layer thicknesses is between 20 and 50 μm.

13. The seamless tubular casing according to claim 1, wherein the sum of the layer thicknesses is between 20 and 30 μm.

14. The seamless tubular casing according to claim 1, wherein casing is biaxially stretched with an area stretching ratio of 4-10 and degree of reshrinkage can be adjusted by the heat setting, a shrinkage at 100° C. in a water-bath of 0-30%.

15. The seamless tubular casing according to claim 1, wherein casing is biaxially stretched with an area stretching ratio of 6-10 and degree of reshrinkage can be adjusted by the heat setting, a shrinkage at 100° C. in a water-bath of 10-20%.
